(19) United States
(12) Patent Application Publication
(10) Pub. No.: US 2004/0005111 A1
(43) Pub. Date: Jan. 8, 2004

(54) Collimator array and optical switch using the same

(75) Inventors: Tadaaki Ishikawa, Tsuchiura-shi (JP); Ryoji Okada, Chiyoda-machi (JP); Teruhisa Akashi, Moriya-shi (JP); Takeshi Harada, Abiko-shi (JP); Atsushi Kazama, Chiyoda-machi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/600,294

(22) Filed: Jun. 20, 2003

(30) Foreign Application Priority Data
Jun. 20, 2002 (JP) 2002-179310
Apr. 17, 2003 (JP) 2003-112302

(51) Int. Cl. G02B 6/26; G02B 6/42

(52) U.S. Cl. 385/16

(57) ABSTRACT

The present invention provides a collimator lens array with an accurate optical axis direction and a high positional accuracy. According to the present invention, a collimator lens array is formed by mounting fiber collimators in respective concaves formed on a bench at appropriate positions to form a collimator row and by stacking up a plurality of such benches. Concaves for engagement with positioning members are formed in each of the front and back surfaces of each bench. The bench positioning concaves are engaged with the corresponding positioning members to accurately position the benches. Thus, a collimator lens array is formed which has a high two-dimensional accuracy.

### BACKGROUND OF THE INVENTION

The present invention relates to an optical switch comprising a plurality of collimator lenses.

A method of ensuring arrangement accuracy by bundling together fiber collimator which have been formed in a cylinder with a high external shape accuracy as described in JP-A-6-214138 has been used, or a method of mounting collimate lenses and fibers in grooves machined with a high positional accuracy as described in JP-A-2001-242339 has been used.

However, with the known manners, it has become difficult to provide devices having sufficiently accuracy. In particular, accompanying with miniaturization of spatial optically-coupled type devices, a collimator lens array with a higher accuracy in an optical-axis direction and a position is desired.

However, for a three-dimension spatial optically-coupled type device that inputs an optical signal to a fiber through a space, what is called, a three-dimension spatial coupling type matrix type optical switch and a wavelength selecting type switch, or a matrix type optical transmission module having a plurality of semiconductor lasers, fiber collimators each composed of fibers and a lens system are required to guide optical signals that have traveled through a space, to fibers or to output optical signals from the fibers as collimated light. To obtain a high optically-coupling efficiency, the optical axes of the fiber collimators must be parallel with one another and must be arranged at predetermined positions. Thus, a collimator lens array is required in which the fiber collimators are accurately arranged in a matrix with their optical axis directions aligned with one another.

With the method according to JP-A-6-214138, the positions of the fiber collimators are defined by stacking up the cylinders. Thus, errors in external shape accuracy of the cylinders are accumulated. If a large number of fiber collimators are assembled together, the positional accuracy of fiber collimators located away from a reference position disadvantageously decreases in both horizontal and vertical directions.

On the other hand, with the method shown in JP-A-2001-242339, the positions of the individual fiber collimators are defined by grooves formed in a bench. Accordingly, the fiber collimators cannot be stacked up particularly in the vertical direction. It is thus difficult to construct a matrix collimator lens array precisely.

It is thus an object of the present invention to provide an optical switch with few losses.

### BRIEF SUMMARY OF THE INVENTION

A feature of the present invention is that a collimator lens array with an accurate optical-axis direction and high positional accuracy by forming concave grooves or through-holes in each of a front and a back surface of a bench on which fiber collimators are mounted and using concaves and members engaging with them to accurately assemble a plurality of benches together.

In the present invention, the fiber collimators are mounted in the concave grooves formed at correct positions on the bench to constitute a collimator row, and a plurality of collimator rows are stacked up to form a collimator lens array. Each bench is formed with the concave grooves or through-holes in each of its front and back surfaces so as to engage with positioning members. Then, the positioning concave grooves in each bench are engaged with the positioning members to accurately determine positional relationship among the benches. Thus, a collimator lens array is formed which has a high two-dimensional positional accuracy.

To solve the above-described prior art problems, the present invention provides a collimator lens array in which fiber collimators are two-dimensionally arranged, each of the fiber collimator being composed of fibers and collimate lenses optically coupled to the respective fibers. In this collimator lens array, the plurality of fiber collimators is arranged in corresponding concave grooves accurately arranged and formed on a single bench. The benches are stacked up to two-dimensionally arrange the collimators. The benches are aligned with one another by engaging the concaves formed in each bench with aligning members having spherical or cylindrical sides. Therefore, the fiber collimators are two-dimensionally arranged accurately.

Specifically, the present invention is configured as described hereinafter.

According to one aspect of the invention, there is provided an optical switch comprising an input side collimator lens array having a plurality of optical fibers to each of which an optical signal is inputted, a switching mechanism for an optical signal path, and an output side collimator lens array having a plurality of optical fibers that output switched optical signals, wherein at least one of the input side and output side collimator lens arrays comprises a first substrate and a second substrate arranged above the first substrate, and the first substrate has collimator lenses in optical communication with the optical fibers, mounting grooves which are formed in a main surface of the first substrate and in each of which the corresponding collimator lens is mounted and first positioning grooves formed in the main surface, and the second substrate has collimator lenses in optical communication with the optical fibers, mounting grooves which are formed in a main surface of the second substrate and in each of which the corresponding collimator lens is mounted and through-holes. The first substrate and the second substrate are arranged via positioning members each arranged between the corresponding first positioning groove and through-hole.

The second substrate has second positioning grooves in the main surface in which the mounting grooves are formed.

At least one of the first positioning grooves and the first through-holes has a surface formed along a crystal face of the substrate.

Each collimator lens is arranged in the corresponding mounting groove formed in at least one of the input side collimator lens array and the output side collimator lens array, via an elastic member having a smaller elastic modulus than the substrate in which the mounting groove is formed.

Alternatively, the elastic member may be arranged between the collimator lens and the second substrate or on both sides.

Further, each fiber collimator is not glued to the corresponding fiber collimator mounting groove on the bench but is fixed by being urged by the elastic member located between the bench and the bench arranged above. This eliminates the need to individually fix the fiber collimators by gluing or the like to allow assembly operations to be performed easily and efficiently. Further, when a plurality of stacked benches are assembled together as a collimator lens array, it is expected that the appropriate force is exerted between the positioning grooves and the positioning members.

Furthermore, the elastic member is composed of Si or its compound and is used to urge the fiber collimators against the mounting grooves for fixation. This reduces the degradation of reliability of the elastic member owing to secular changes. Further, the number of parts required for assembly can be reduced to make assembly operations more efficient.

The through-holes are formed from the same side as that in which the mounting grooves are formed.

For example, the positioning through-holes in each bench can be created using as a reference the same surface of the bench that the fiber collimator mounting grooves are formed. Further, the through-holes are integrated with the grooves to minimize positional deviations during formation. Furthermore, since the through-holes are formed using the fiber collimator mounting surface as a reference, it is possible to reduce the positional deviations between the through-holes and the fiber collimator mounting grooves.

Further, the positioning through-holes and the fiber collimator mounting grooves can be efficiently formed by an etching operation using a single etching mask. For example, positional deviations can further be reduced.

A plurality of collimator lens mounting grooves are formed in each of the first and second substrates.

An upper end of each positioning member mounted between the substrates is formed higher than an upper end of each collimator lens mounted on the first substrate.

Further, according to another aspect of the invention, there is provided an optical switch comprising an input side collimator lens array having optical fibers to each of which an optical signal is inputted, a switching mechanism for an optical signal path, and an output side collimator lens array having optical fibers that output switched optical signals, wherein at least one of the input side collimator lens array and the output side collimator lens array comprises a first substrate, first mounting grooves which are formed in a main surface of the first substrate and in each of which a first collimator lens is mounted, first positioning grooves arranged with the mounting grooves between, second positioning grooves formed in a surface opposite to the main surface and arranged with the mounting grooves between, a second substrate arranged opposite the main surface of the first substrate, third positioning grooves formed in a surface of the second substrate which is opposite the first substrate and at positions opposite to the first positioning grooves, a third substrate arranged opposite the opposite surface of the first substrate, fourth positioning grooves formed in a surface of the third substrate which is opposite the first substrate and at positions opposite to the second positioning grooves, first positioning members each arranged between the corresponding first positioning groove and third positioning groove, and second positioning members each arranged between the corresponding second positioning groove and fourth positioning groove, wherein the first positioning groove located in a first direction with respect to the mounting grooves of the first substrate is formed in an area located at a distance larger than a distance from the mounting grooves till the corresponding second positioning groove and the first positioning groove located in an opposite direction of the first direction with respect to the mounting grooves of the first substrate is formed in an area located at a distance smaller than the distance from the mounting grooves till the corresponding second positioning groove.

Alternatively, the arrangement of the collimator lens array described above can be used to provide an optical device comprising optical fibers through each of which an optical signal is input and output, wherein inside a housing of the optical device, optical signals from the fiber are converted into collimated lights for use or an optical signal from an internal light source is optically coupled to the fiber.

Alternatively, the arrangement of the collimator lens array described above can be used to provide an effective form of an optical switch comprising optical fibers through each of which an optical signal is input and output, wherein inside a housing of the optical device, an optical signal path is switched after an optical signal is converted into a collimated light. It is thus possible to efficiently convert an optical signal from the fiber into a collimated light or optically couple a collimated light to the optical fiber.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a perspective view of the first embodiment of a collimator lens array according to the present invention.

FIG. 2 is a schematic view showing an example of the structure of essential parts of an optical switch utilizing the first embodiment.

FIG. 3 is a view of a part of the first embodiment as viewed from its lens side.

FIG. 4 is a view of a bench as viewed from above.

FIG. 5 is a schematic view illustrating the operation of the elastic member in a second embodiment of the present invention.

FIG. 6 is a plan view of a bench of a third embodiment of the collimator lens array of the present invention.

FIG. 7 is a view of the third embodiment shown in FIG. 6 as viewed from a lens side.

FIG. 8 is a plan view of the bench according to a fourth embodiment of the collimator lens array of the present invention.

FIG. 9 is a sectional view illustrating a holding structure based on a Si elastic member in a fifth embodiment of the collimator lens array of the present invention.

FIGS. 10, 11, and 12 are plan views showing examples of structures of the Si elastic members.

FIG. 13 is a sectional view illustrating the action of the Si elastic members shown in FIG. 12.

FIG. 14 is a perspective view of a sixth embodiment of the collimator lens array of the present invention.

FIG. 15 is a front view of the sixth embodiment.

FIG. 16 is a top view of an elastic member (plate spring) for holding a collimator lens in the sixth embodiment.

FIG. 17 is a sectional view showing that no load is imposed on one plate spring.

FIG. 18 is a sectional view showing that the plate spring shown in FIG. 16 holds a collimate lens.

FIG. 19 is a front view of a seventh embodiment of the collimator according to the present invention.

FIGS. 20 and 21 are plan views of collimate lens pressing elastic members according to the present invention.

FIG. 22 is a schematic view illustrating the operation of the collimate lens pressing elastic member shown in FIG. 20.

### DETAILED DESCRIPTION OF THE INVENTION

The present invention will be described hereinafter with reference to the drawings.

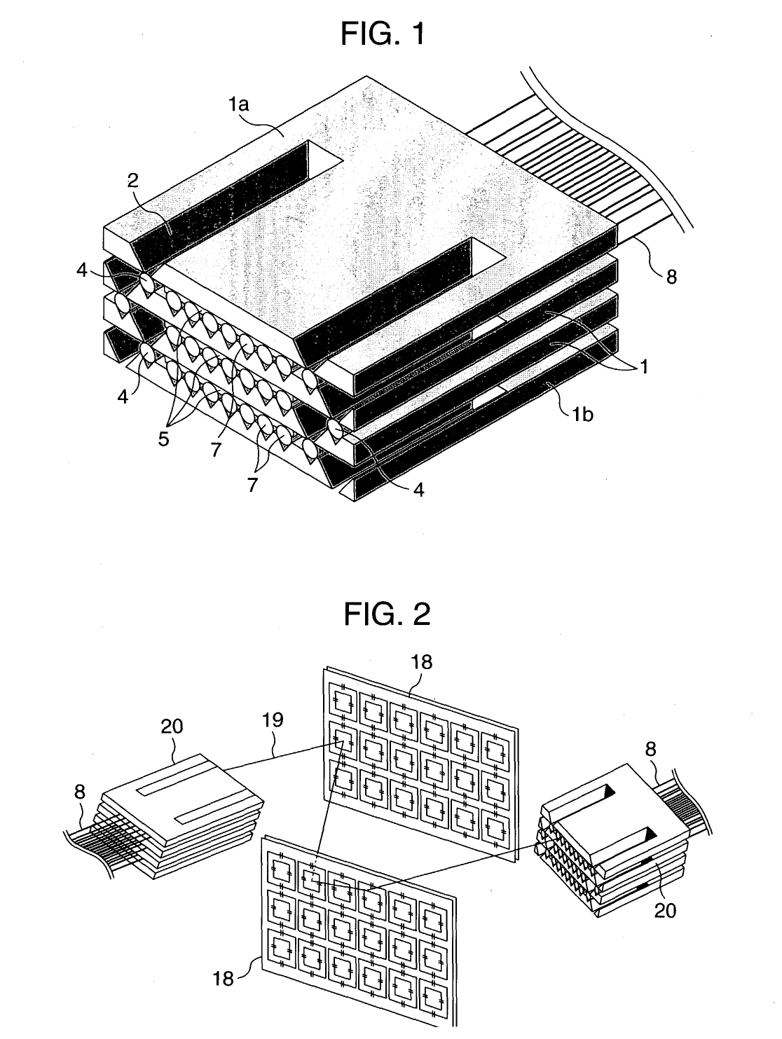

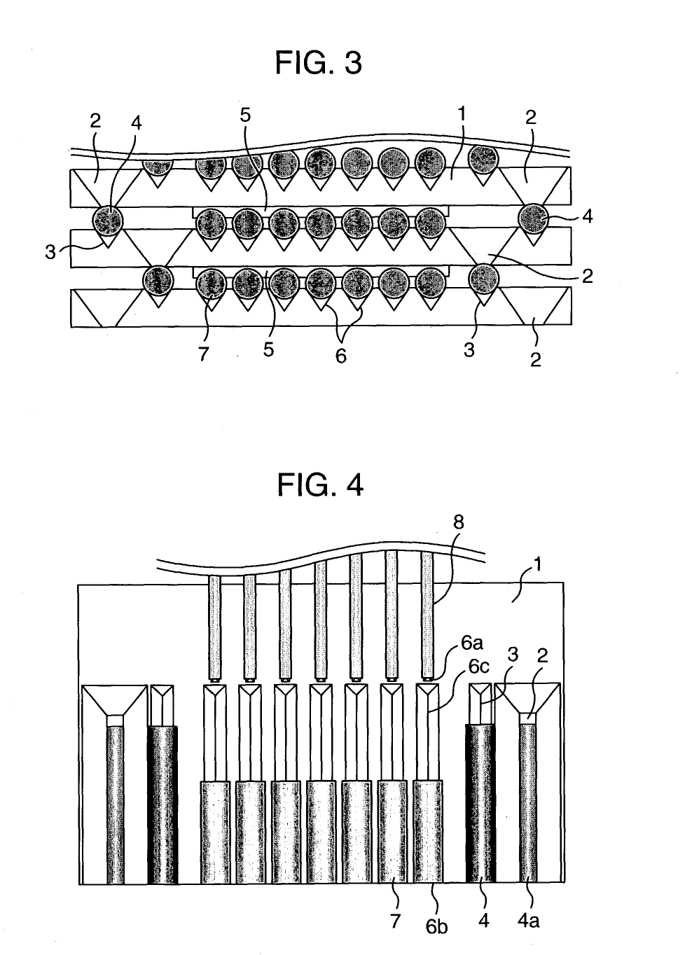

FIGS. 1, 2, 3, and 4 are views showing a first embodiment of a collimator lens array according to the present invention and an example of its use as a component of an optical switch. FIG. 1 is a perspective view of the first embodiment. FIG. 2 is a schematic view showing an example of the structure of essential parts of an optical switch utilizing the first embodiment. FIG. 3 is a view of a part of the first embodiment as viewed from its lens side. FIG. 4 is a view of a bench as viewed from above. In the present embodiment, as shown in FIG. 1, the collimator lens array comprises fiber collimators each comprising a collimate lens 7 and a fiber 8, a bench 1b for a bottom, benches 1 which has through-holes 2 and on which the fiber collimators are mounted, a bench 1a for a top, elastic members 5 for holding down the collimate lenses 7 and the fibers 8, and positioning pins 4 that engage with the corresponding through-holes 2 to position the benches.

The fiber collimator has a function of outputting an optical signal from the corresponding fiber 8 as an aligned collimated light via the corresponding collimate lens 7 or optically coupling an optical signal input to the collimate lens 7 to the optical fiber 8. The collimator lens array comprises the fiber collimators arranged in a matrix.

As shown in FIG. 2, the collimate array 20 is often used in an optical switch, notably a spatial-connection or three-dimensional optical switch in which an optical signal from a fiber is converted into collimate light 19, which is then reflected by a movable mirror on a mirror array 18 to switch an optical path so that the light is optically coupled to the fiber again and then output. If the collimator lens array 20 is used as a component of such an optical switch, it is desirable that the fiber collimators have optical axes parallel with one another and are accurately positioned in a matrix in point of designing of the mirror array and facilitating of assembling and adjustment of the whole switch.

Referring to FIGS. 3 and 4, the optical fibers 8, through each of which an optical signal propagates, are mounted in respective fiber mounting grooves 6a on the benches 1. The optical fibers 8 are each optically coupled to the collimate lens 7 which has a cylindrical cross section and which is mounted in a corresponding collimate lens mounting groove 6b via an optical path groove 6c. A pair of the optical fiber 8 and the collimate lens 7 forms one fiber collimator. The collimate lens 7 can be composed of a spherical lens. The fiber 8 and the collimate lens 7 are fixed by being pressed against the corresponding grooves using the elastic member 5. Since the fiber 8 and the collimate lens 7 have different diameters, their mounting grooves have different widths and depths.

As method of forming grooves of different depths on the same bench, there are cutting with a dicer, dry etching, molding with a mold and the like which are used depending on the type of bench material. However, a method based on a wet etching process and using Si as a bench material is simplest and suitable for mass production because it requires only one mask and enables the simultaneous processing of a plurality of wafers to which a mask has been transferred. The engagement of the positioning pins 4 is utilized to position each bench. The bench 1 is provided with grooves 3 that are positioning pin mounting concaves and through-holes 2 that are concaves in its back surface. The benches are accurately positioned in the vertical and horizontal direction by engaging the positioning pins 4 mounted in the corresponding grooves 3 with the corresponding through-holes 2 in the bench above. Preferably, the positioning grooves are formed from the same side as that of the collimator optical system mounting grooves 6. Consequently, the benches can be accurately positioned. In particular, accurate etching can be easily accomplished by using the wet etching process to form the grooves so that each of them has a surface along a crystal face. Further, the use of the wet etching process enables the positioning pin mounting grooves 3 and the through-holes 4 to be formed in a mask used to form lens mounting grooves or the like. Accordingly, this formation can be accomplished during the same process, thus improving productivity. Further, it is possible to increase the accuracy of the horizontal positions of the through-holes 2 and positioning pin mounting grooves 3 with respect to the fiber collimator optical system.

If the grooves engaging with the positioning pins 4 are formed in the back surface of the bench separately from the pin mounting grooves 3, it is difficult to accurately align the grooves on the front surface of the bench with the grooves on the back surface. The present structure enables positioning to be accomplished easily and accurately, significantly contributing to increasing productivity. The positioning pins 4 engage with the through-holes 2 formed using the same mask as used to form fiber collimator optical system grooves and therefore, positioning accuracy of the fiber collimators among the benches can be assured.

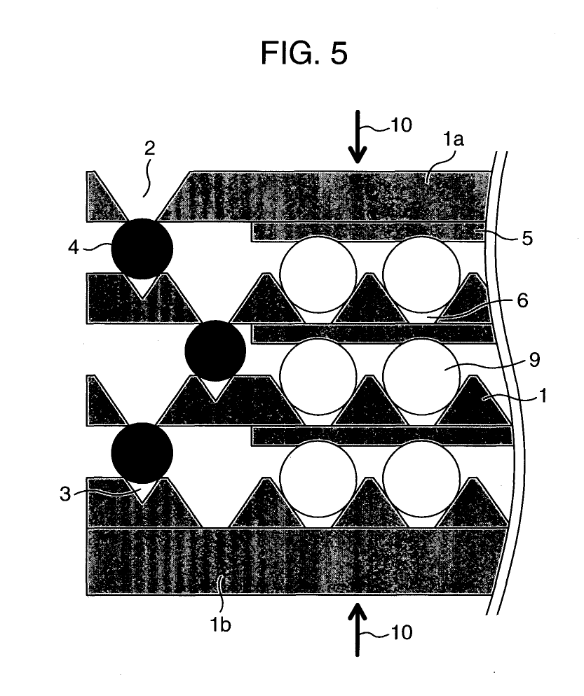

FIG. 5 is a schematic view illustrating the operation of the elastic member in a second embodiment of the present invention.

In the second embodiment, the fiber collimator optical system mounting grooves 6 also penetrate the bench 1. The collimator lens array holds its structure by exerting an inward pressing force 10 on an uppermost bench 1a acting as a cover and on a lowermost bench 1b, with the benches 1, in which the fiber collimator optical systems 9 are mounted, and the elastic members 5 sandwiched between the benches 1a and 1b.

The elastic member 5 is desirably composed of a material such as silicon rubber, a spring material of metal, or an Si structure which undergo few secular changes and which are highly resistant to environments. The elastic member 5 allows the fiber collimator optical systems 9 to be surely pressed against the mounting grooves 6 for positioning and fixation without relying on gluing or fusion even if there is any error in the shape of the fiber collimator optical systems 9 or mounting grooves 6. Further, the elastic member 5 serves to appropriately disperse the pressing force 10 acting on the benches and prevents that the bottom openings of the through-holes 2 are damaged or deformed by concentration of loads on the positioning pins 4 and the through-holes 2.

An appropriate material for the positioning pins 4 has a high dimensional accuracy and a high rigidity and is unlikely to be thermally deformed as in the case with the bench 1. A particularly suitable material is Kovar, glass, or ceramics such as alumina. However, the positioning pins 4 may be composed of optical lenses. If the positioning pins 4 are composed of fiber collimator optical system lenses to output collimated light, collimated light for centering the optical axis of the collimate array is obtained without using the fiber collimator optical systems 9 arranged in a matrix.

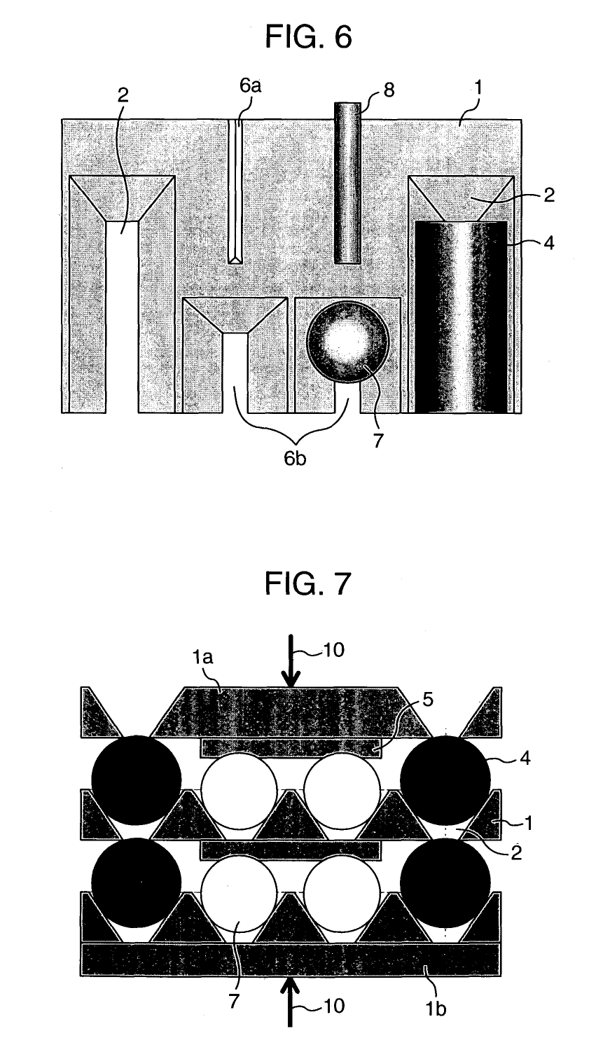

FIG. 6 is a plan view of a bench of a third embodiment of the present invention. FIG. 7 is a view of the third embodiment shown in FIG. 6 as viewed from a lens side. In FIG. 6, the positioning pins, lenses, and fibers in the left half are omitted. In the third embodiment, each collimate lens 7 is a ball lens, and each positioning through-hole 2 also acts as a positioning pin mounting groove. In this structure, since the positioning through-hole 2 also acts as a positioning pin mounting groove, the width of the bench 1 can be reduced. It is thus expected that the size and material cost of the collimate array can be reduced. Further, owing to the reduced number of grooves required for positioning, it is expected that the positional accuracy of the grooves and thus of the benches is improved. The diameter of the positioning pin 4 can be formed to be larger than that of the collimate lens 7.

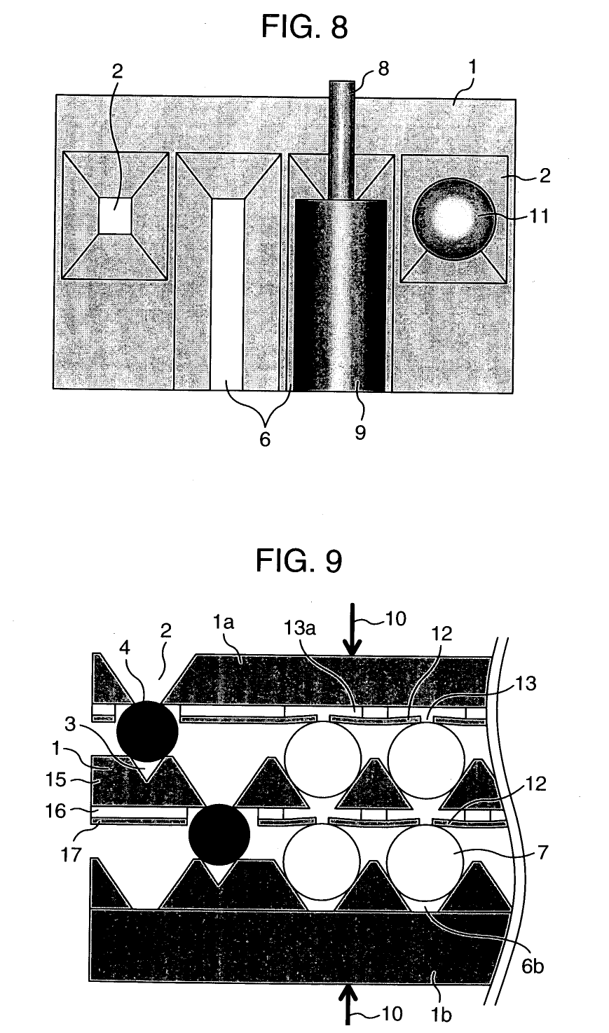

FIG. 8 is a plan view of the bench according to a fourth embodiment of the present invention. In the fourth embodiment, each fiber collimator 9 is composed of the collimate lens 7 and fiber 8 already integrated with one another and is mounted in the corresponding fiber collimator mounting groove 6. In this structure, a single core fiber collimator can be used. Further, in the present embodiment, a positioning ball 11 is used as a positioning member and is mounted, for positioning, in the corresponding positioning through-hole 2 also acting as a positioning ball mounting groove. The ball is shaped like a bearing, a spherical lens, or the like. An arbitrary shape may be used as long as it has a high dimensional accuracy.

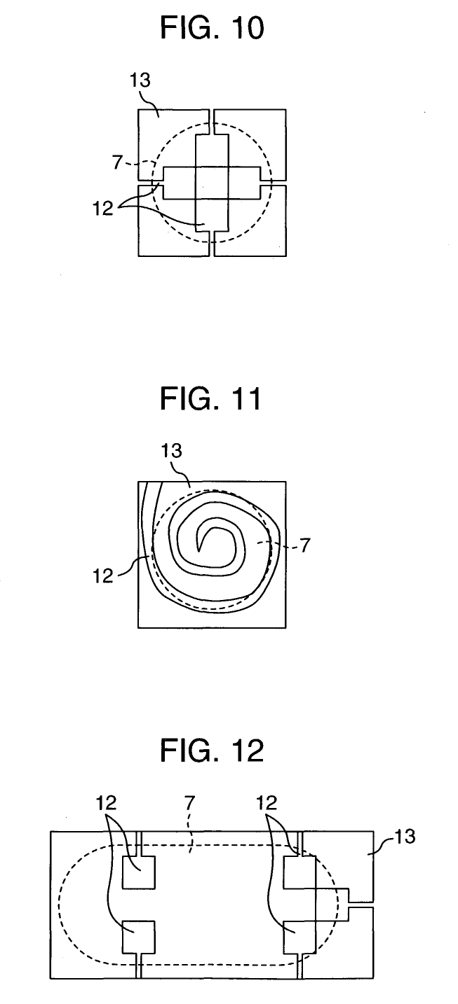

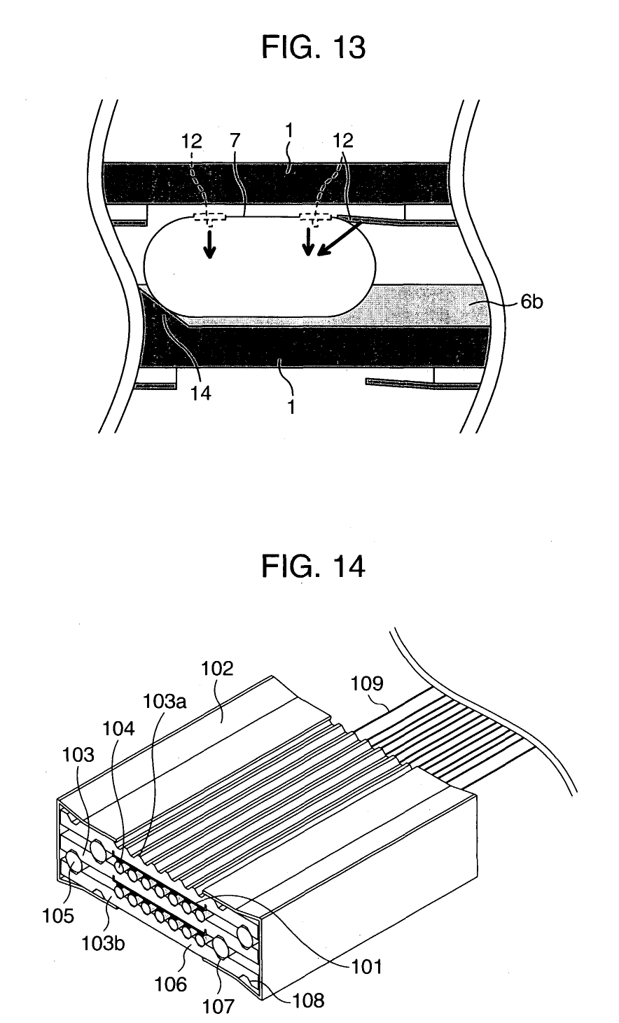

FIG. 9 is a sectional view illustrating a holding structure based on a Si elastic member according to a fifth embodiment of the present invention. FIGS. 10, 11, and 12 are plan views showing examples of structures of the Si elastic members. FIG. 13 is a sectional view illustrating the action of the Si elastic members shown in FIG. 12. In the fifth embodiment shown in FIG. 9, an elastic member 12 that holds the collimate lens 7 is made of Si and is provided on the back surface of the bench 1. This elastic member is obtained by forming Si into a very thin cantilever of thickness 100 gm or less. It is used under a load that does not exceed the range of elastic deformation. If a Si layer as an elastic member is too thick, its processing requires much time and labor, thus degrading productivity. Further, it is effective to determine the width and length of the elastic member 12 and the number of elastic members on the basis of the size of the lens 7 and the elastic force required for the Si elastic member 12. However, the lens 7 can be stably supported if the elastic member 12 comes into contact with the lens at at least two locations.

To form the Si elastic members 12 on the back surface of the bench 1, it is suitable to use an SOI wafer, which is a stacked material of Si and SiO₂, as a material for the bench 1, in terms of the strength of the Si layer, constituting the Si elastic member. In this case, the SOI wafer is utilized with an Si layer 15 thick enough to allow the lens mounting grooves 6b and positioning through-holes 2 to be formed in this layer, and a much thinner Si layer 17 located below the Si layer 15 via an SiO₂ layer 16 of a predetermined thickness.

First, as with the other cases, the through-holes 2, the positioning pin mounting grooves 3, and the fiber collimator optical system mounting grooves 6 are formed by wet etching. At this time, because of difference in etching speed between Si and SiO₂, the SiO₂ layer 16 is not completely penetrated even at the positions of the through-holes 2. Then, holes 13 are formed in the thin Si layer 17 in the back surface of the bench 1 by dry etching so as to structure the the Si elastic members 12. At this time, the Si layer 17 is removed even from the through-holes 2. Then, the exposed SiO₂ layer 16 is selectively removed by wet etching to form a gap 13a between the surface Si layer 15 and the Si elastic members 12 which is as large as the thickness of the SiO₂ layer 16. Thus, the Si elastic members 12 can be operated. The Si elastic members 12 simply hold the fiber collimator optical systems. Further, the position and size of each through-hole 2 are determined by etching from the surface. Accordingly, the positional accuracy of processing of the Si layer from the back surface has a tolerance of several dozen μm. The Si elastic member may have any of various possible planar shapes depending on the shape of the collimate lens or fiber collimator to be held.

FIGS. 10 and 11 show examples of planar shapes of Si elastic members for holding a ball lens as an example. FIG. 12 shows an example of a Si elastic member holding a cylindrical lens or a fiber collimator. When the Si elastic member 12 is omitted in one direction as shown in FIG. 12 and the lens 7 is pressed against a terminal 14 of a lens mounting groove 6b as shown in FIG. 13, the lens can be more firmly held.

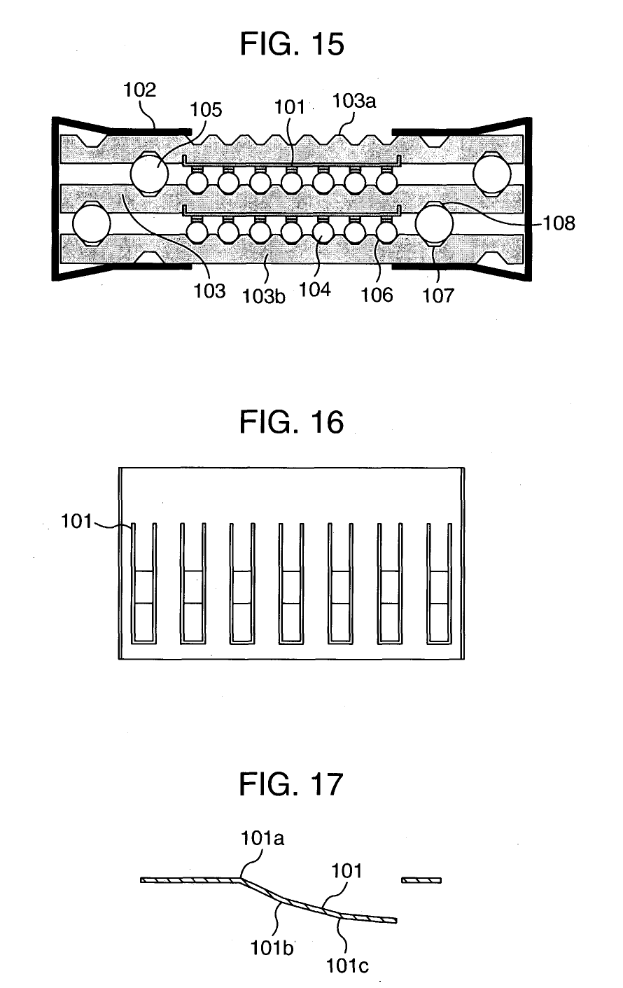

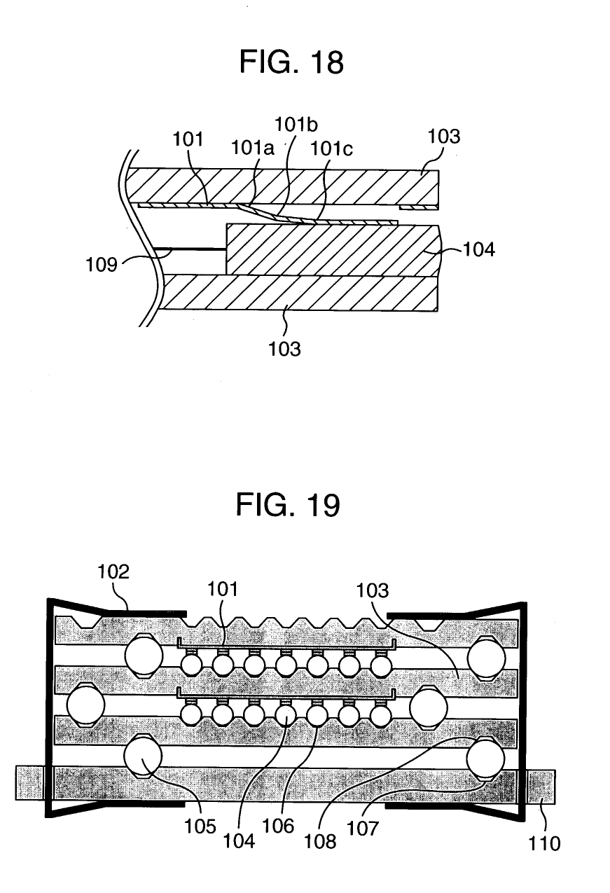

FIGS. 14, 15, 16, 17, and 18 are views showing a sixth embodiment of a collimator lens array according to the present invention. FIG. 14 is a perspective view of the present embodiment. FIG. 15 is a front view of the present embodiment. FIG. 16 is a top view of an elastic member (plate spring) for holding a collimator lens in the present embodiment. FIG. 17 is a sectional view showing that no load is imposed on one plate spring. FIG. 18 is a sectional view showing that the plate spring shown in FIG. 16 holds a collimate lens.

In the present embodiment, as shown in FIGS. 14 and 15, the collimator lens array comprises fiber collimators each consisting of a collimate lens 104 and a fiber 109, benches 103, 103a, and 103b each having mounting grooves 106 in which the corresponding fiber collimators are mounted, top surface positioning grooves 107, and bottom surface positioning grooves 108, a plate-spring-like elastic member 101 that is used to hold the collimate lens 104, top surface positioning grooves 107, positioning pins 105 that engage with the corresponding top and bottom surface positioning grooves 107, 108 to position the benches, and a clip-like metal spring elastic member 102 that clamps the benches 103, 103a, and 103b combined together via the positioning pins. The configuration serves to press the benches. It has pressing portions disposed on each of the uppermost and lowermost ones of the plurality of stacked benches and a connecting portion connecting them together. Thus, the uppermost and lowermost benches are pressed to tightly connect the stacked benches together.

In the present embodiment, the positions of the positioning grooves 107 and 108 at either end of each bench appear to differ between the benches 103 and 103a and 103b. However, the mounting grooves 6 and the positioning grooves 107 and 108 are present from front end to rear end of each bench. Accordingly, if a front of the bench 103 is replaced with the rear of the bench 103, its arrangement will be the same that those of the benches 103a and 103b. As a result, there is only one type of bench, and thus the number of parts required can be reduced.

In this aspect, the first bench 103 is formed with first mounting grooves 106 which are formed in a main surface of the first bench 103 and in each of which a first collimator lens 104 is mounted, first positioning grooves 107 arranged with the mounting grooves 106 between, second positioning grooves 108 formed in a surface opposite to the main surface and arranged with the mounting grooves 106 between, the second bench 103a is arranged opposite the main surface of the first bench 103, and is formed with third positioning grooves 108 formed in a surface of the second bench 103a which is opposite the first bench 103 and at positions opposite to the first positioning grooves 107. The third bench 103b is arranged opposite the opposite surface of the first bench 103, and is formed with fourth positioning grooves 107 formed in a surface of the third bench 103b which is opposite the first bench 103 and at positions opposite to the second positioning grooves 108. The first positioning members 105 each is arranged between the corresponding first positioning groove 107 and third positioning groove 108. The second positioning members 105 each is arranged between the corresponding second positioning groove 108 and fourth positioning groove 107. The first positioning groove 107 located in a first direction with respect to the mounting grooves 106 of the first bench 103 is formed in an area located at a distance larger than a distance from the mounting grooves 106 till the corresponding second positioning groove 108. The first positioning groove 107 located in an opposite direction of the first direction with respect to the mounting grooves 106 of the first bench 103 is formed in an area located at a distance smaller than the distance from the mounting grooves 106 till the corresponding second positioning groove 108.

The independent collimator lenses 104 are each mounted, for positioning and orientation, in the corresponding mounting groove 106, formed on each bench in a predetermined direction with a high dimensional accuracy. The mounting grooves 106 are formed by precision machining using a dicer.

The benches, the positioning members, and the collimator lenses preferably have the same coefficient of linear thermal expansion. Since quartz, Si, borosilicate glass, pyrex glass, or the like is used as the lens, Kovar, 42 alloy, quartz, pyrex glass, borosilicate glass, ferrite, ceramics, or the like is used as the bench. Dimensional accuracy is especially important for the positioning members. Therefore, cylinders of zirconia, pyrex glass, or borosilicate glass are inexpensive and especially suitable for the positioning members.

Elastic members 101 to press and hold the collimator lens 104 against the mounting grooves 106 are, for example, a leaf spring and it is a single plate having a plurality of leaf spring elements so that a plurality of collimator lens can be fixed to each bench. Opposite ends of each elastic member 101 are folded upward to engage with positioning grooves (not shown) on the bottom surface of each bench to position itself with respect to the bench. Each plate spring elements has at least three bent portions 101a, 101b, and 101c as shown in FIG. 17 so as to avoid a point contact with the cylindrical collimator lens 104. As shown in FIG. 18, when the plate spring element is pressed against the collimate lens 104, its part located in the front of the bent portion 101c follows the shape of the collimate lens 104. Thus, the collimate lens 104 is pressed horizontally against the corresponding mounting groove in the bench 103. Therefore, the collimate lens can adequately follow the shape of the mounting groove.

As the elastic member, a metal material is excellent for a long time. A spring material such as phosphor bronze, a SUS material which is unlikely to get rusty, and a metal material plated with gold and the like to avoid getting rusty are suitable.

Further, it is possible to inexpensively form the mounting and positioning grooves in the substrate (bench) by machining with a dicer or the like. The wet etching process enables a large amount of grooves to be formed at a time. However, with this process, the depth of the grooves is determined by the width of a mask transferred to the substrate, using the surface of the substrate as a height reference. Consequently, the positional accuracy of the collimator lenses fixed and aligned in the mounting grooves are markedly affected by the thickness accuracy of the substrate and a variation in thickness within a surface resulting in low accuracy.

On the other hand, with machining with a dicer, the depth of the grooves is adjusted on the basis of the height of a blade from a table on which an object to be worked is placed. Accordingly, by firstly machining the positioning grooves in the back surface of the substrate opposite the main surface in which the mounting grooves are formed, and then, turning the substrate upside down, setting the substrate by aligning the positioning grooves with positioning members of a high dimensional accuracy, and then forming the mounting and positioning grooves for the collimator lenses, it is possible to work the mounting and positioning grooves on the basis of the positioning grooves in the back surface. Thus, even if a plurality of substrates are stacked up, the collimator lenses can be accurately aligned regardless of the thickness accuracy of the substrates or a variation in thickness within a surface. In view of machinability, an excellent material for the bench includes Si or ferrite. Furthermore, by employing a structure in which similar positioning grooves are formed in also the housing accommodating the collimator lens array and the collimator lens array is clamped and fixed to the housing via the positioning members using the elastic members, the need to provide separate components used as members for fixing the collimator lens array to the housing is eliminated. Therefore, productivity can be improved.

Further, holding in a condition in which the benches are assembled together as a collimator lens array is carried out by clipping metal spring 102, and there is no glued portions. Consequently, if any problem occurs such as a disconnection of any fiber or a defect in any lens, the replacement of the lens or the like can be easily carried out by removing the clipping metal spring 102 and disassembling the collimate lens array. Further, in the drawing, the positioning grooves 107 and 108 are formed parallel with one another in one direction. The benches cannot be positioned in a fore-and-aft direction using only these grooves. However, this positioning can be accomplished by forming separate positioning grooves extending in a direction different from the one in which the positioning grooves 107 and 108 extend and engaging these grooves with one another via positioning members. In the present embodiment, by forming a pair of positioning grooves orthogonal to the positioning grooves 107 and 108 near the front and rear ends of each bench at predetermined positions where the mounting of the collimate lenses is not obstructed, the fore-and-aft positioning can be reliably accomplished while maintaining the interchangeability of the benches.

Thus, an aspect of the present invention is characterized in that the collimator lenses are pressed against and fixed to the corresponding mounting grooves in the surface of the bench using the elastic members. Further, the positioning grooves are formed in each of the front and back surfaces of the bench on which the collimator lenses are mounted. Then, these grooves and members engaging with them are used to accurately assemble a plurality of benches. All the benches are then pressed against one another for fixation using the second elastic members. The pressing mechanism is provided on the second and third benches sandwiching the first bench between them to press them against the first bench. This eliminates the need for an adhesive and the limitation of materials such as in the case with welding. It is therefore possible to provide an environment-resistant collimator lens array with a high positional accuracy.

The present invention also provides a collimator lens array which resists the adverse effects of environments during the fixation of the collimator lenses or the like.

The collimator lenses are held and fixed to the mounting or positioning grooves using the pressing force of the elastic members and the frictional force exerted between the elastic members and the grooves. Even with a change in humidity, the pressing force always acts. Accordingly, in spite of expansion or contraction of the benches, collimator lenses, or positioning members themselves, whirling of the collimator lens or the like is prevented. Further, compared to the use of an adhesive such as epoxy resin, problems such as outgassing and the wear or deformation of the adhesive do not occur even with degradation. Furthermore, since the collimator lenses are simply held using the elastic members, even if the disconnection of any fiber, a defect in any lens, or the like occurs, it is possible to replace only the relevant lens.

FIG. 19 shows a seventh embodiment of the present invention. In this embodiment, the collimator lens array is positioned in a housing 110 using a similar method of positioning the benches using the positioning grooves 107 and 108 and positioning members 105. Then, the clipping elastic member 102 is used to press all the benches and the housing. As in the case with the previous embodiment, the positional and directional accuracies of each collimate lens are determined with high accuracy by the positional and directional accuracies of the grooves machined using a dicer. No adhesives are used. The pressing force on the mounting grooves 106 always acts on the collimate lenses 4 so as to position them. Thus, this collimator lens array resists the adverse effects of environments such as a change in temperature.

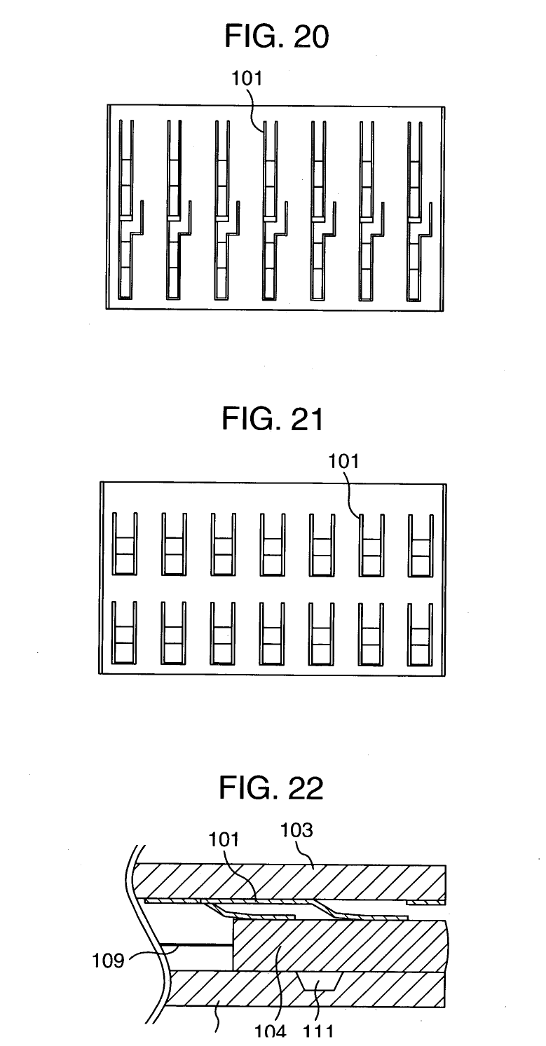

FIGS. 20, 21, and 22 are views illustrating another embodiment of a collimate lens pressing elastic member 101 according to the present invention. In contrast with the elastic member 1, shown in FIG. 16, the plate-spring-like elastic member 101, shown in FIGS. 20 and 21, is composed of two plate spring elements that press one collimate lens 4. As shown in FIG. 22, if a groove 111 is present under the collimator lens 104, the total length of the collimator lens 104 is so large that a single pressing point is insufficient, or a point contact occurs owing to the low dimensional accuracy of the external shape of the collimate lens 104, then the number of pressing points is increased to avoid point contacts with the elastic member 101 or mounting grooves. This enables the collimator lenses to be mounted more stably. With this, an optical device with few losses is provided.

According to the present invention, an optical device can be provided which suffers few losses.

It should be further understood by those skilled in the art that although the foregoing description has been made on embodiments of the invention, the invention is not limited thereto and various changes and modifications may be made without departing from the spirit of the invention and the scope of the appended claims.

1. An optical switch comprising an input side collimator lens array having a plurality of optical fibers to each of which an optical signal is input, a switching mechanism for an optical signal path, and an output side collimator lens array having optical fibers that output switched optical signals,
wherein at least one of said input side collimator lens array and said output side collimator lens array comprises:
a first substrate having mounting grooves which are formed in a main surface of said first substrate and in each of which a corresponding collimator lens in optical communication with the optical fiber is mounted, and first positioning grooves formed in said main surface;
a second substrate having mounting grooves which are formed in a main surface of said second substrate and in each of which a corresponding collimator lens in optical communication with the optical fiber is mounted, and through-holes; and
positioning members respectively arranged between said first positioning grooves and first through-holes.

2. The optical switch according to claim 1, wherein said second substrate has second positioning grooves in the main surface in which the mounting grooves are formed.

3. The optical switch according to claim 1, wherein at least one of said first positioning grooves and said through-holes are formed by surfaces along a crystal face of said substrate.

4. The optical switch according to claim 1, wherein the collimator lens are respectively arranged in the mounting grooves formed in at least one of said input side collimator lens array and said output side collimator lens array, via an elastic member having a smaller elastic modulus than the substrate in which said mounting grooves are formed.

5. The optical switch according to claim 1, wherein said through-holes are formed from the same side as that in which said mounting grooves are formed.

6. The optical switch according to claim 1, wherein a plurality of collimator lens accommodating grooves are formed in each of said first and second substrates.

7. The optical switch according to claim 1, wherein an upper end of each of said positioning members mounted between said substrates is formed higher than an upper end of each of the collimator lenses mounted on said first substrate.

8. An optical switch comprising an input side collimator lens array having a plurality of optical fibers to each of which an optical signal is input, a switching mechanism for an optical signal path, and an output side collimator lens array having optical fibers that output switched optical signals,
wherein at least one of said input side collimator lens array and said output side collimator lens array comprises:
a first substrate having first mounting grooves which are formed in a main surface of said first substrate and in each of which a first collimator lens is mounted, first positioning grooves arranged at both sides of said mounting grooves; second positioning grooves formed in a surface opposite to said main surface and at both sides of an area corresponding to an area in which said mounting grooves are formed;
a second substrate arranged opposite said main surface of said first substrate, and having third mounting grooves formed in a surface of said second substrate which is opposite said first substrate and at positions opposite to said first positioning grooves;
a third substrate arranged opposite said opposite surface of said first substrate, and having fourth positioning grooves formed in a surface of said third substrate which is opposite said first substrate and at positions opposite to said second positioning grooves;
first positioning members arranged between said first positioning grooves and third positioning grooves; and
second positioning members arranged between said second positioning grooves and fourth positioning grooves,
wherein said first positioning groove located in a first direction with respect to the mounting grooves of the first substrate is formed in an area located at a distance larger than a distance from the mounting grooves till the second positioning groove, and
said first positioning groove located in an opposite direction of the first direction with respect to the mounting grooves of the first substrate is formed in an area located at a distance smaller than the distance from the mounting grooves till the corresponding second positioning groove.

9. A collimator lens array comprising a plurality of collimator lenses in communication with optical fibers, said collimator lens array comprising:
a first substrate having first mounting grooves which are formed in a main surface of said first substrate and in each of which a first collimator lens is mounted, first positioning grooves formed with said mounting grooves between; second positioning grooves formed in a surface opposite to said main surface and with an area corresponding to an area in which said mounting grooves are formed between;
a second substrate arranged opposite said main surface of said first substrate, and having third mounting grooves formed in a surface of said second substrate which is opposite said first substrate and at positions opposite to said first positioning grooves;
a third substrate arranged opposite said opposite surface of said first substrate, and having fourth positioning grooves formed in a surface of said third substrate which is opposite said first substrate and at positions opposite to said second positioning grooves;
first positioning members arranged between said first positioning grooves and third positioning grooves; and
second positioning members arranged between said second positioning grooves and fourth positioning grooves,
wherein said first positioning groove located in a first direction with respect to the mounting grooves of the first substrate is formed in an area located at a distance larger than a distance from the mounting grooves till the second positioning groove, and
said first positioning groove located in an opposite direction of the first direction with respect to the mounting grooves of the first substrate is formed in an area located at a distance smaller than the distance from the mounting grooves till the corresponding second positioning groove.

10. A collimator lens array comprising a plurality of collimator lenses in communication with optical fibers, said collimator lens array comprising:
a first substrate having first mounting grooves which are formed in a main surface of said first substrate and in each of which a first collimator lens is mounted, first positioning grooves arranged said mounting grooves between; second positioning grooves arranged in a surface opposite to said main surface and with an area corresponding to an area in which said mounting grooves are formed between;
a second substrate arranged opposite said main surface of said first substrate, and having third mounting grooves formed in a surface of said second substrate which is opposite said first substrate and at positions opposite to said first positioning grooves;
a third substrate arranged opposite said opposite surface of said first substrate, and having fourth positioning grooves formed in a surface of said third substrate which is opposite said first substrate and at positions opposite to said second positioning grooves;
first positioning members arranged between said first positioning grooves and third positioning grooves;
second positioning members arranged between said second positioning grooves and fourth positioning grooves, and
a pressing mechanism that presses said second substrate and said third substrate against said first substrate.
